(19) United States
(12) Patent Application Publication
(10) Pub. No.: US 2024/0291773 A1
(43) Pub. Date: Aug. 29, 2024

(54) RESOURCE SHARING BETWEEN USERS ACROSS APPLICATIONS IN A UNIFIED SUITE

(71) Applicant: Zoho Corporation Private Limited, Chengalpattu Taluk (IN)

(72) Inventors: Lokesh Srinivasalu, Chennai (IN); Manikandan Govindarajan, Chennai (IN); Vidhyasagar Dhachinamurthi, Coimbatore (IN)

(21) Appl. No.: 18/589,229

(22) Filed: Feb. 27, 2024

Related U.S. Application Data
(60) Provisional application No. 63/498,263, filed on Apr. 25, 2023.

(30) Foreign Application Priority Data
Feb. 28, 2023 (IN) 202341013535

(51) Int. Cl. H04L 47/70; G06F 3/0481; G06F 3/0486

(52) U.S. Cl. CPC H04L 47/82; G06F 3/0481; G06F 3/0486; G06F 2203/04803

(57) ABSTRACT

A system and method for seamless resource sharing among web applications bundled into a software suite are disclosed. The present disclosure addresses the problem of manually downloading and uploading a resource from one web application to another web application inside a unified system, using Drag & Drop or Copy & Paste using a clipboard. One or more resources can be shared by a user from a source web application. The meta information of the resource is shared with a resource sharing server, and the network resource of the user machine is not used in the download and upload process. The clipboard used in the Copy & Paste functionality facilitates pasting the content copied by users across multiple web applications, different sessions, and different devices. While sharing the resources, the permissions of the sender and receiver on the shared resource are used to filter the original resource using a permission filter and share only that which is permitted. In addition to these permissions, the receiver's preferences on modification or augmentation to the original resource is also facilitated with the help of a preference mask.

### CROSS-REFERENCE TO RELATED APPLICATIONS

The present application claims priority to Indian Provisional Patent Application No. 20234,1013535 filed Feb. 28, 2023 and U.S. Provisional Patent Application Ser. No. 63/498,263 filed Apr. 25, 2023, each of which is incorporated by reference herein.

### BACKGROUND

Resource sharing among web applications bundled into a software suite, takes place by downloading a resource from a source application server and uploading to a destination application server. The downloading and uploading operations are done by the user manually, and a drag and drop or a copy of the resource resides in a user machine. For the entire data transfer, a user's network data is used.

### BRIEF DESCRIPTION OF DRAWINGS

FIG. 1 illustrates an architecture of a resource sharing system without a resource sharing server (Drag & Drop).

FIG. 2 illustrates an architecture of a resource sharing system with a resource sharing server (Drag & Drop).

FIG. 3 is a screen shot displaying a ghost image while resource sharing.

FIG. 4 is a screen shot displaying a dragged resource moved over a valid drop target.

FIG. 5 is a screen shot displaying sharing in progress in drag and drop mode.

FIG. 6 is a screen shot indicating a resource shared to a destination in drag and drop mode.

FIG. 7 is a screen shot showing split view through an application context menu.

FIG. 8 is a screen shot showing split view through drag and drop.

FIG. 9 is a screen shot of split view.

FIG. 10 depicts a flowchart for implementing drag and drop.

FIG. 11 illustrates an architecture of a resource sharing system without a resource sharing server (Copy-Paste).

FIG. 12 illustrates an architecture of a resource sharing system with a resource sharing server (Copy-Paste).

FIG. 13 is a screen shot of copying the resource to clipboard.

FIG. 14 is a screen shot of pasting the resource.

FIG. 15 is a screen shot of resource sharing in progress.

FIG. 16 is a screen shot indicating a resource shared to a destination.

FIG. 17 depicts a flowchart for illustrating the process of resource sharing using a clipboard in web applications.

FIG. 18 illustrates an overall architecture of the resource sharing model.

FIG. 19 is a flowchart depicting the steps involved in sharing a resource from a source application to a destination application in a unified software suite (Drag & Drop).

### DETAILED DESCRIPTION

### Resource Sharing using Drag & Drop

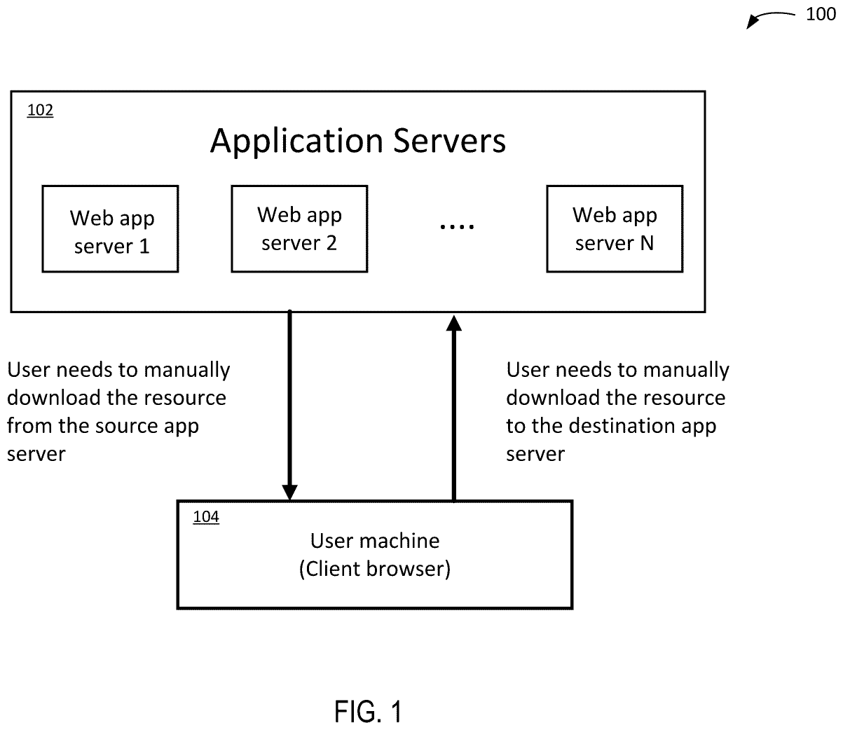

When there is a need to share resources among applications in an office suite, a user must normally download the resource from the source application manually. The resource shared can be an attachment in an email, a file saved in a folder, a file shared in a messaging application, or a file shared in an internal forum, to name a few examples. The downloaded resource is then saved on the user machine. To share the resource, the user must upload the resource to the destination application again manually. FIG. 1 is a diagram 100 of application servers 102 and a user machine 104. The user manually downloads a resource from the application servers 102, specifically a source application server, to the user machine 104. The user later uploads the resource from the user machine 104 to the applications servers 102, specifically a destination application server. This manual uploading and downloading process as shown in FIG. 1, utilizes network resources. Also, a copy of the downloaded resource exists in the user machine, until the user deletes it manually.

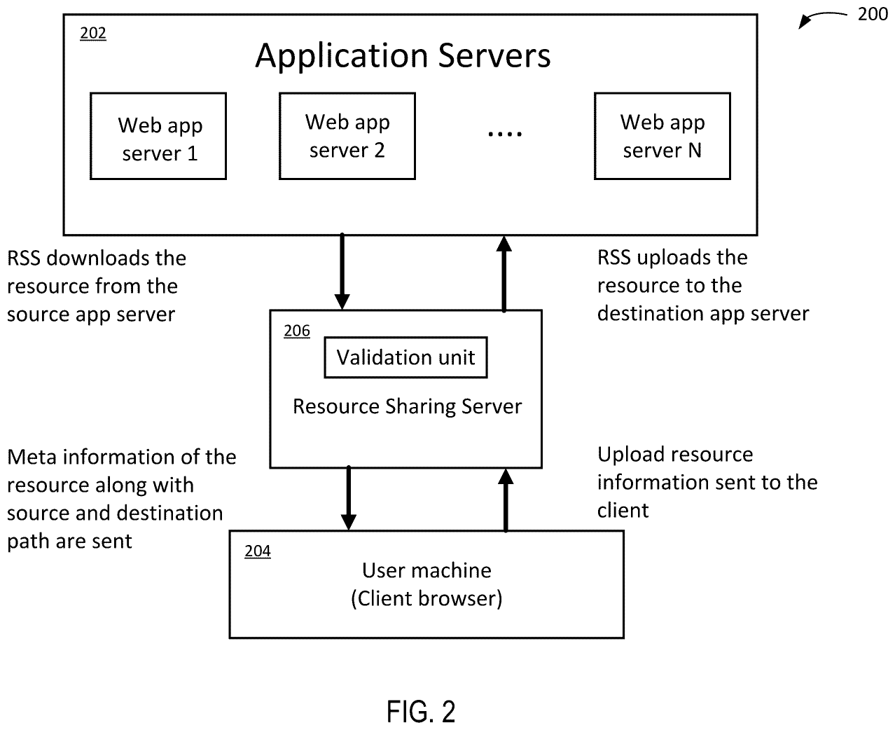

To overcome the above problems, resource sharing takes place with the help of a resource sharing server. FIG. 2 is a diagram 200 of resource sharing from application servers 202 from a user machine 204 using a resource sharing server 206 intermediary. Resource sharing in the workplace as shown in FIG. 2, happens between two applications in a seamless way by sharing meta information. In an example of operation, when a user drag and drops, at the user machine 204, a resource from one application to another, the resource sharing server 206 downloads the resource from the application servers 202, specifically a source application server, and uploads the same to a destination application server of the application servers 202.

A validation unit of the resource sharing server 206 validates the download payload and upload payload information before initiating download and upload from and to the web applications. Payload contains unique identification of a file along with, in a specific implementation, file name, file size, file type, and source/destination directory/path from where the file has to be downloaded/uploaded. The user machine 204 sends the meta information such as file name, file type, and file size to the resource sharing server 206 along with the source and destination information. Because the user machine 204 sends only the meta information of the resource to the resource sharing server 206, fewer network resources are utilized compared to a file upload/download. The resource sharing server 206 uses the meta information to transfer resources from the source to the destination. The resource sharing server 206 acts as an intermediate server between the application servers 202 and the user machine 204 and holds the resource dragged from the source application until it is dropped to the destination application. Once the resource is shared to the destination, the resource sharing server 206 can send the uploaded meta information to the user machine 204.

The system described in association with FIG. 2, and other descriptions in this paper, makes use of a computer-readable medium (CRM) to couple components of the system. The CRM and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The CRM and other computer readable mediums discussed in this paper are intended to represent a variety of potentially applicable technologies. For example, the CRM can be used to form a network or part of a network. Where two components are co-located on a device, the CRM can include a bus or other data conduit or plane. Where a first component is co-located on one device and a second component is located on a different device, the CRM can include a wireless or wired back-end network or LAN. The CRM can also encompass a relevant portion of a WAN or other network, if applicable.

The devices, systems, and computer-readable mediums described in this paper can be implemented as a computer system or parts of a computer system or a plurality of computer systems. As used in this paper, a server is a device or a collection of devices. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g., “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor that is a component of the engine. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

A database management system (DBMS) can be used to manage a datastore. In such a case, the DBMS may be thought of as part of the datastore, as part of a server, and/or as a separate system. A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

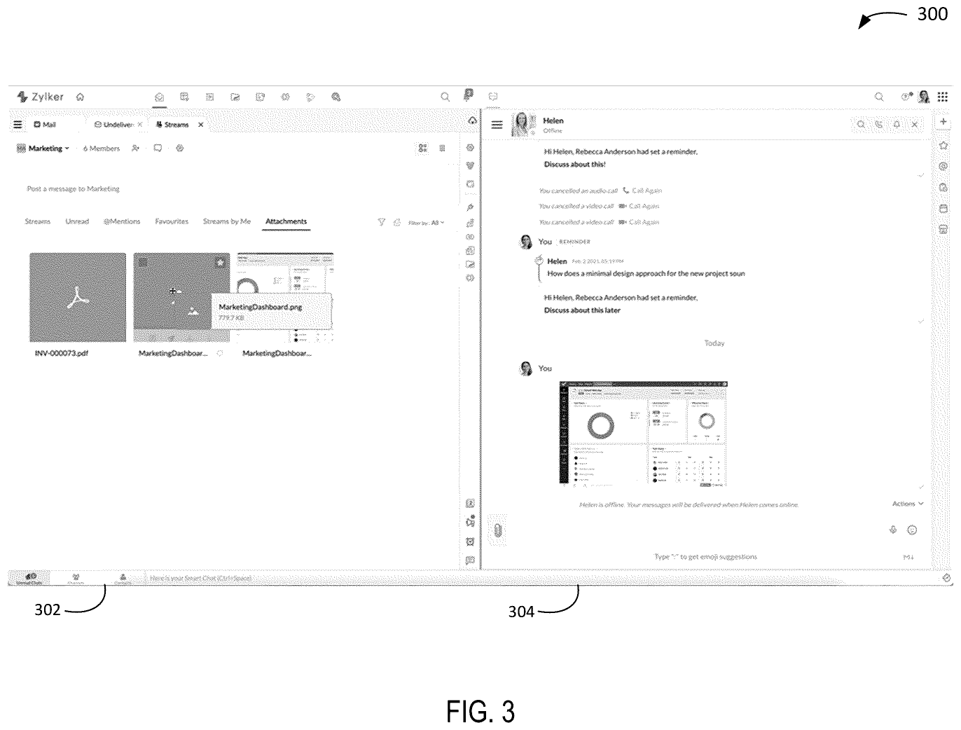

Referring once again to the example of FIG. 2, in a specific implementation, to differentiate between the application's own drag case from the proposed Web Applications Resource Sharing (WARS), a modifier key, example ALT key from an input device like keyboard connected with the user machine, needs to be additionally pressed while dragging the resources. To find the resource information when drag happens, source class is added to the resource's html element from which the meta information of the resource is obtained from the source-meta data attribute. The source-meta is a stringified meta information of the resource which includes, in a specific implementation, file name, file id, file size, file type, etc. While drag is initiated, a ghost image is created. FIG. 3 is a diagram 300 of a split screen comprising a first screen 302 and a second screen 304. The diagram 300 serves as an example of how drag functionality can be implemented. In this example, the ghost image created comprises meta information such as file name, file type, and file size as shown diagram 300.

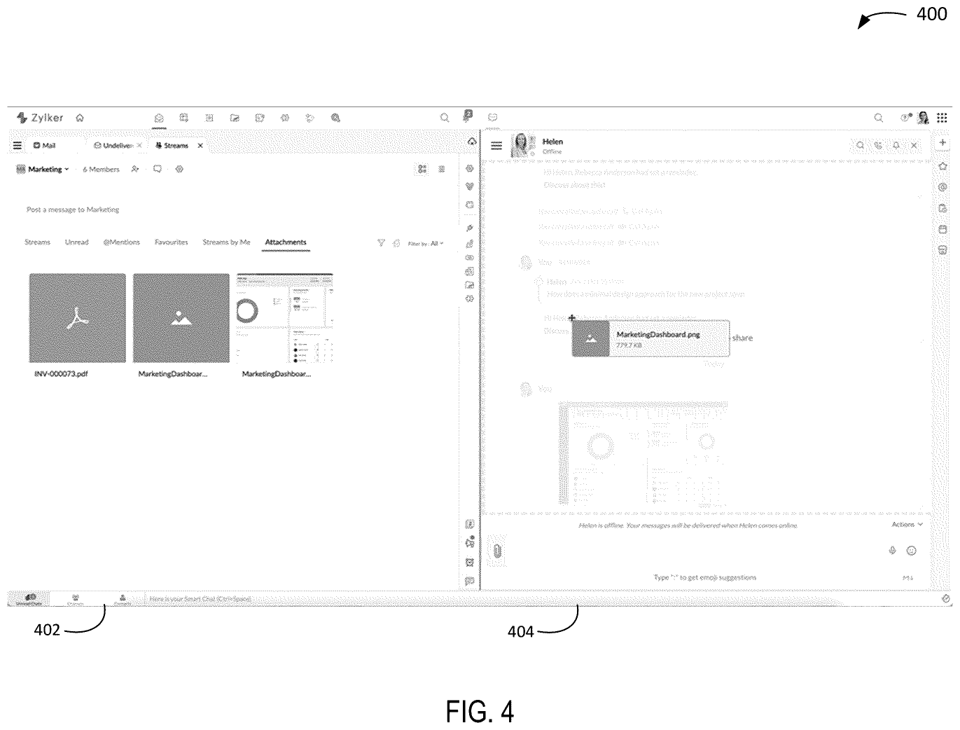

FIG. 4 is a diagram 400 of a split screen comprising a first screen 402 and a second screen 404 that is similar to FIG. 3. When a resource is dragged over a valid drop target as shown in diagram 400, the drop target is highlighted when drag enters and unhighlighted once the drag leaves the drop target. In a specific implementation, to find drop targets, destination class is added to the drop region elements from which the meta information of the drop region will be obtained from the destination-meta data attribute.

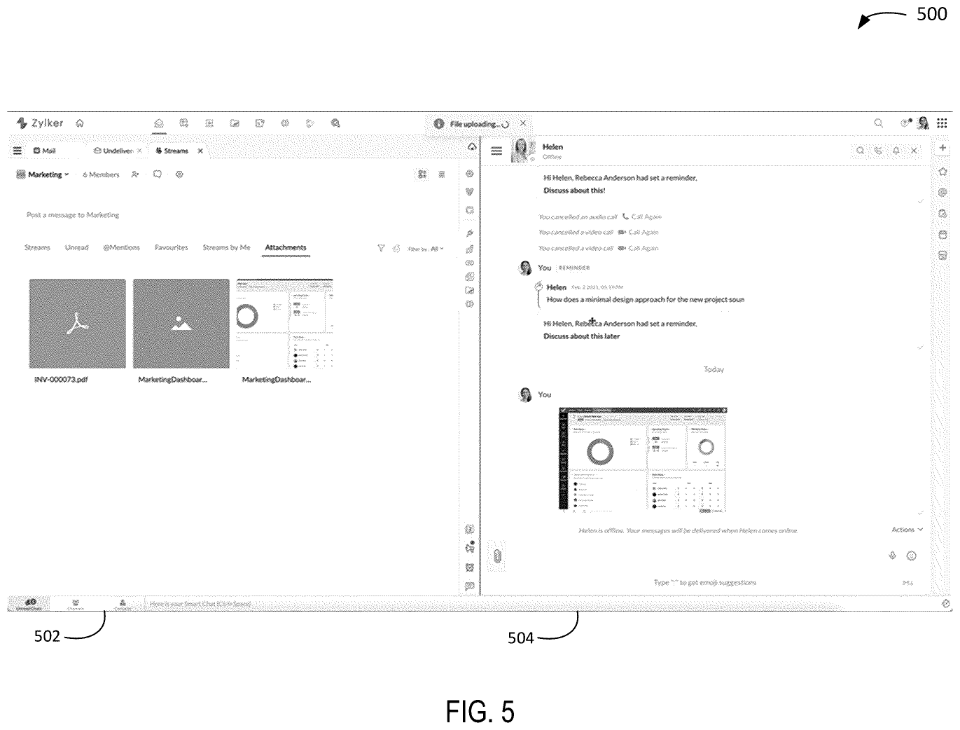

In addition, to evaluate the size that is allowed in the drop region, the allowed resources size is obtained from the destination allowed size data attribute of the valid drop targets. If the drop region allows multiple resources and if there is a limitation on the total resources size, the same is validated by invoking a function so the particular application will validate the size and will return the total size supported; remaining size allowed is used to show proper error messages in case of a size restriction. If the total resource size is within the specified limit, sharing takes place as shown in FIG. 5, which is a diagram 500 of a split screen comprising a first screen 502 and a second screen 504 that is similar to FIGS. 3 and 4.

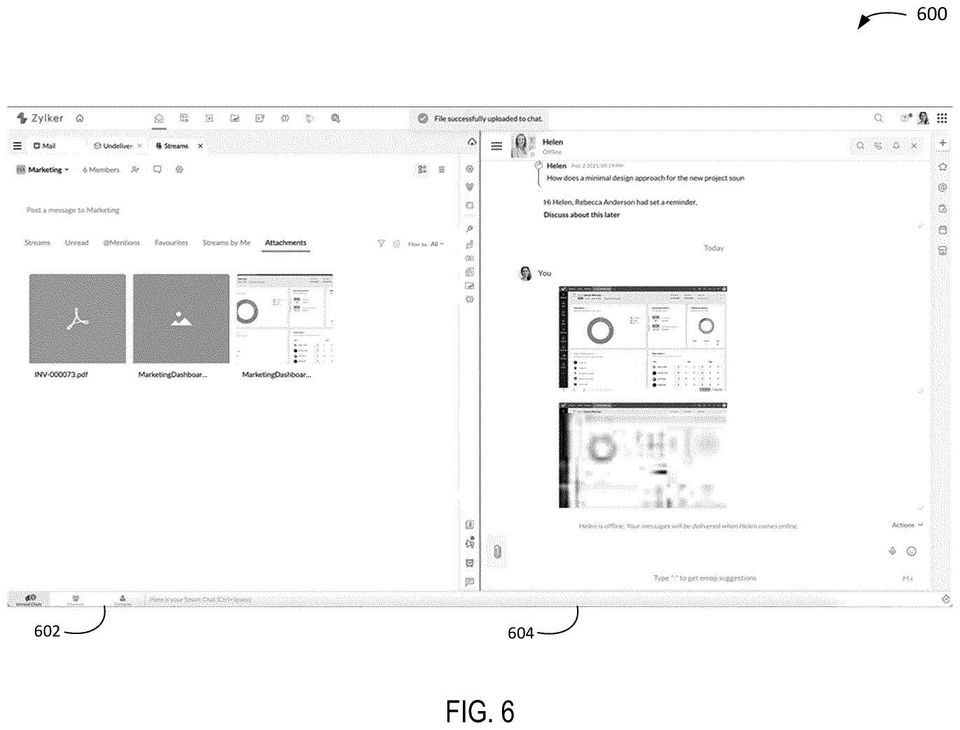

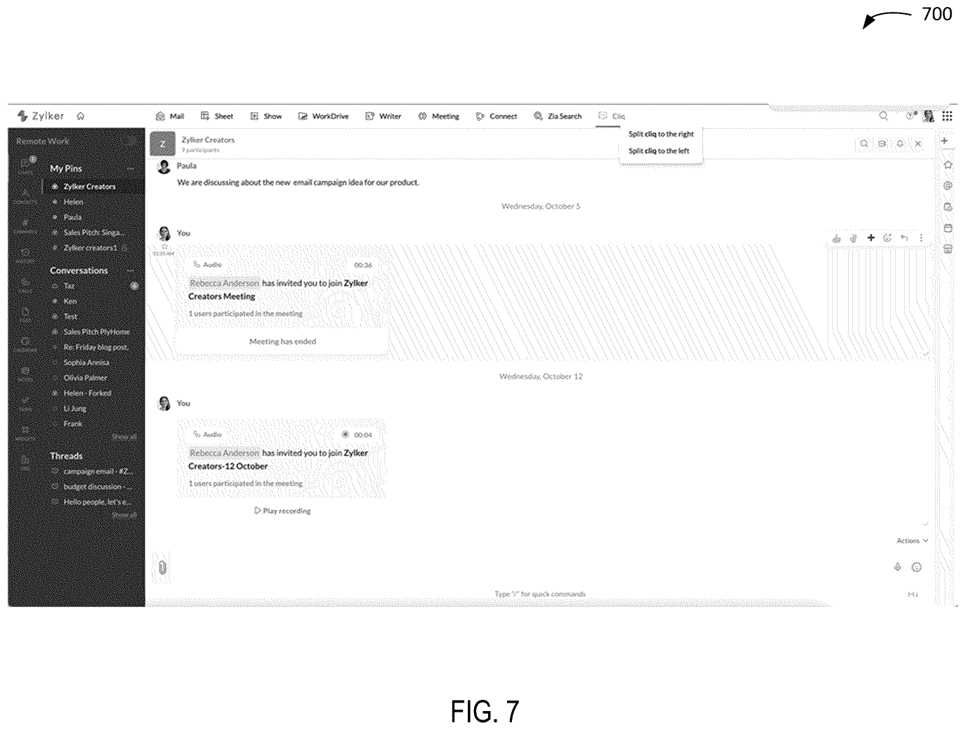

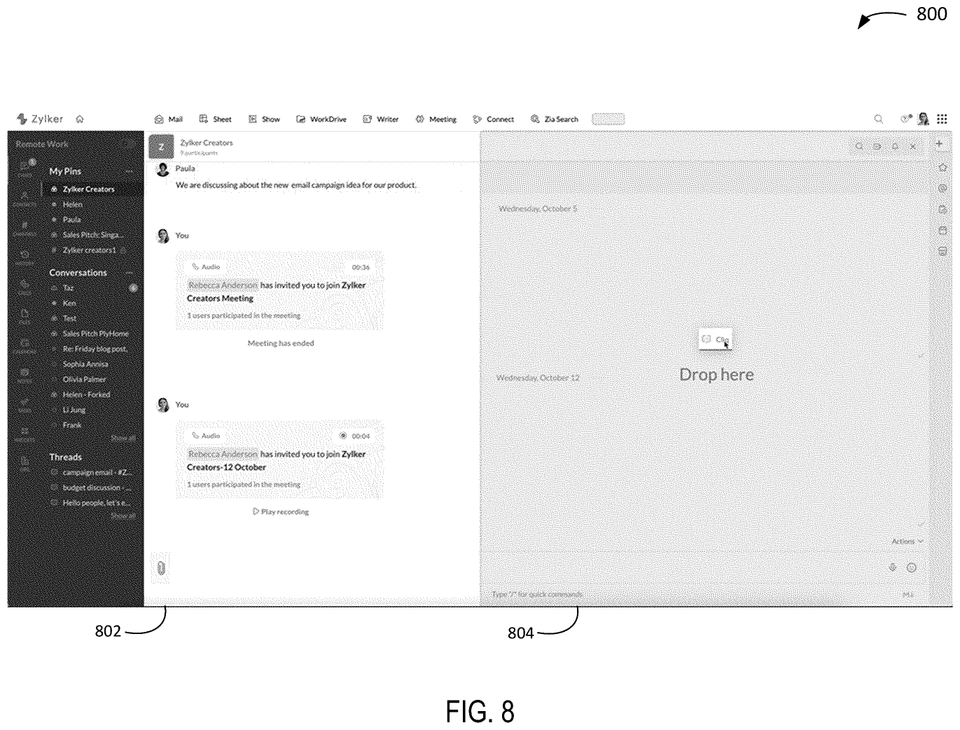

Split screen view is a concept by which users can view two applications side by side as shown in FIG. 6, which is a diagram 600 of a split screen comprising a first screen 602 and a second screen 604 that is similar to FIGS. 3, 4, and 5. Split screen view can be obtained either by dragging and dropping any applications in the center pane to create the split screen of the dropped application and the current viewing application or the dashboard as shown in FIG. 8 (diagram 800, which includes a first screen 802 and a second screen 804 that is similar to FIGS. 3, 4, 5, and 6) or from the context menu of each applications as shown in FIG. 7 (diagram 700). Either two applications or the dashboard and an application can be viewed in the split screen view. Split screen eases the sharing of the resource between two applications by drag and drop. Users can have the source and destination application side by side, so that the resource can be easily dragged from the source application and dropped to the destination application.

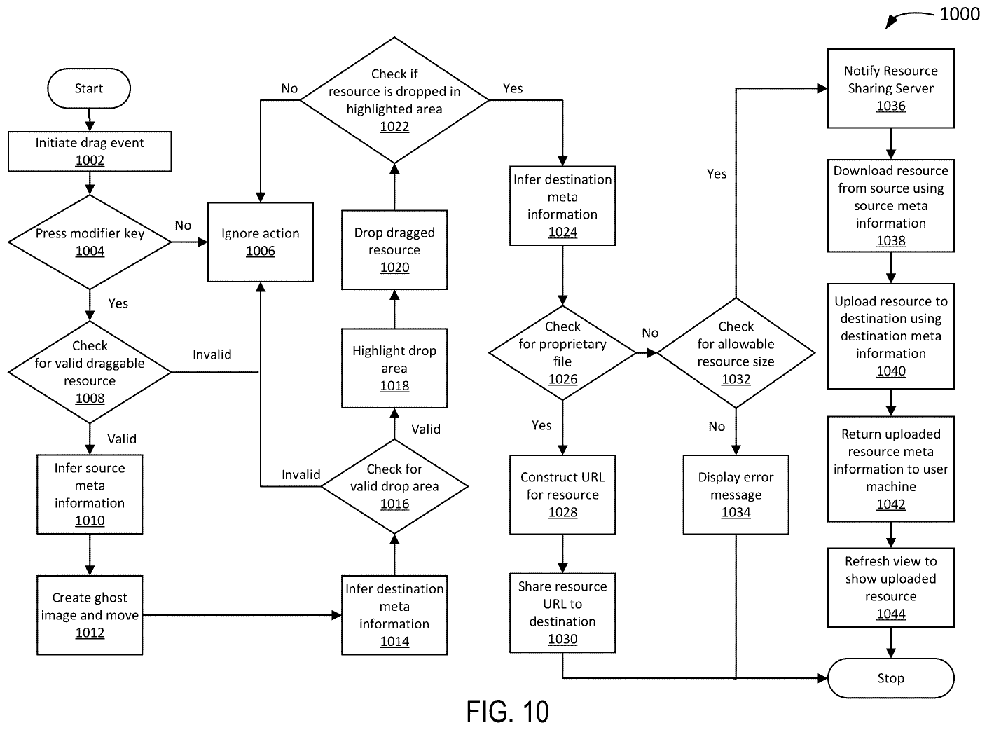

FIG. 10 is a flowchart 1000 of a method of implementing drag and drop for resource sharing across applications in a unified suite. The flowchart 1000 starts at module 1002 with initiating a drag event. In a specific implementation, a ‘mousedown’ event will be listened to in the application's inline frame's body, so that when drag happens ‘mousedown’ event will trigger first.

The flowchart 1000 continues to decision point 1004 where it is determined whether a “modifier key” has been pressed. In this example, the modifier key is a necessary component to signal an attempt to perform resource sharing using an intermediate resource sharing server. As such, if it is determined a modifier key has not been pressed (1004-No), the flowchart ends at module 1006 with ignoring the action. (It may be noted a line from module 1006 to “Stop” has been omitted to avoid unnecessarily obfuscating the flowchart with crossed lines.)

If, on the other hand, it is determined a modifier key has been pressed, the flowchart 1000 continues to decision point 1008 where it is determined whether a valid draggable resource is being dragged. For example, if a ‘WARS’ drag modifier key is pressed, then the element will be checked for the draggable source class name, to find whether the valid draggable resource is clicked. If the above condition satisfies, the default behavior of the ‘mousedown’ event will be prevented and will be listening for the ‘dragstart’ event at the target element and will prevent the default behavior to stop other drag related events getting triggered. The meta information will be taken from the data attribute of the drag target's html element.

If it is determined other than a valid draggable resource is being dragged (1008-Invalid), the flowchart 1000 continues to module 1006 as described previously; otherwise (1008-Valid), the flowchart 1000 continues to module 1010 where source meta information is inferred, to module 1012 where a ghost image is created and moved, and to module 1014 where destination meta information is inferred. In a specific implementation, to create a ghost image of the resource while dragging as shown in, e.g., FIG. 3, some post message events are sent to the parent window to create the resource's ghost image; because while dragging the resource it is likely desirable for the ghost image to be moved along with the mouse cursor, a transparent mask is placed above the application's inline frames and the ‘mousemove’ event is listened for in the parent window. In this way, the ghost image is moved along with the mouse cursor.

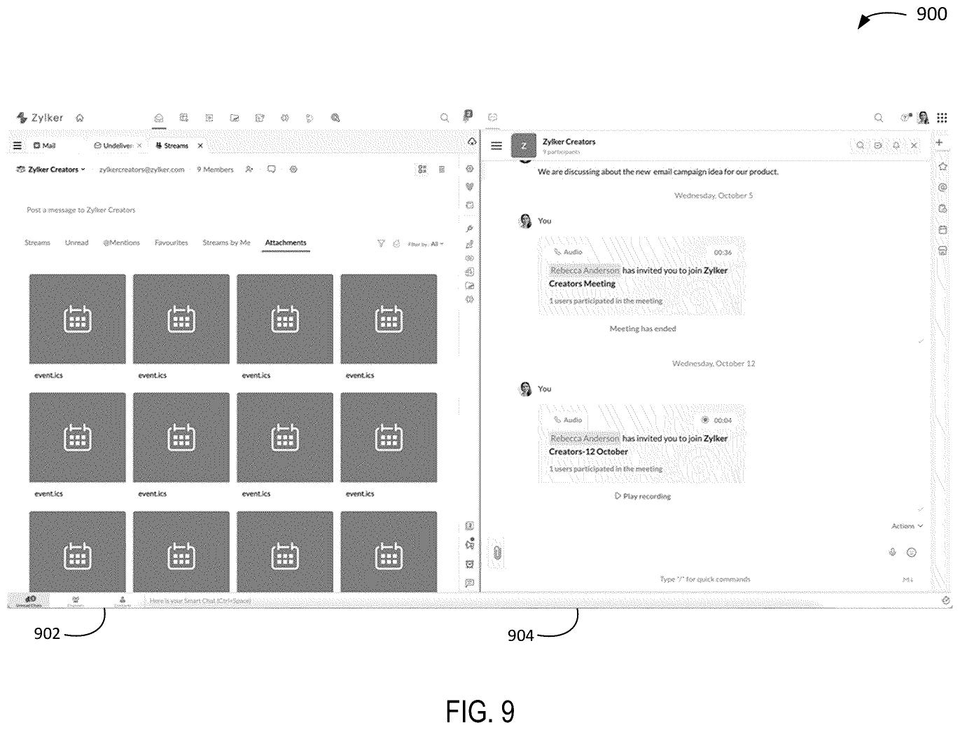

The flowchart 1000 continues to decision point 1016 where it is determined whether a valid drop area is available. If in split view as shown in, e.g., FIG. 9, the dragged resource can be dropped in a target region straight away. Otherwise, some other action may be precedent. For example, the mouse pointer can be hovered over an application's tab name in the header to switch to that application. If it is determined a valid drop area is not available (1016-Invalid), the flowchart 1000 continues to module 1006 as described previously.

Otherwise, the flowchart 1000 continues to module 1018 where a drop area is highlighted and to module 1020 where the dragged (ghost image of the) resource is dropped. Because a transparent mask is placed over the application's inline frames, ‘mousemove’ event will be listened for in the parent window to find whether drag enters a destination application's inline frame. Once the drag enters any destination application's inline frames, valid drop targets will be found with the help of mouse pointer's current x & y co-ordinates. If a valid drop target is found, e.g., elements having the destination class name and the meta information of the drop region are obtained from that drop region.

In a specific implementation, valid drop regions are highlighted by firing a custom ‘dragenter’ event and the same will be removed when the mouse leaves the drop targets, by firing a custom ‘dragleave’ event. In this implementation, an application's inline frames are listening for both the events and handle the cases accordingly, as shown by way of example in FIG. 8. At decision point 1022, it is determined whether a resource has been dropped in a valid drop region (or highlighted area in this example). If not (1022-No), the flowchart 1000 continues to module 1006 as described previously.

Otherwise (1022-Yes), the flowchart 1000 continues to module 1024 where destination meta information is inferred and to decision point 1026 where it is determined whether the resource to be shared with the destination application is a proprietary file. In a specific implementation, for a proprietary file there is no restriction on the size of the resource shared. If the resource is a proprietary file (1026-Yes), the flowchart 1000 continues to module 1028 where a URL (Uniform Resource Locator) for the resource is constructed and ends at module 1030 where the resource URL is shared to the destination along with read (and perhaps other) permission.

If not a proprietary file (1026-No), the flowchart 1000 continues to decision point 1032 where it is determined whether the resource is of an allowable size. If not (1032-No), the flowchart 1000 ends at module 1034 where an error message is displayed. To validate and restrict or allow the resource to be shared to the destination application, application's inline frames set an allowed size data attribute to the droppable targets, so that the dragged resource's size will be validated against the same. For applications/regions supporting multiple resources to an entity such as composing an email, writing a new forum post, writing a new streams message, etc., a method is invoked so the application's inline frames validate the remaining size allowed in that entity with the current dropped resource's size. If the resource size goes beyond the allowable size, then an error message is displayed on the user machine.

Otherwise (1032-Yes), the flowchart 1000 continues to module 1036 with notifying a resource sharing server, to module 1038 with downloading resource from source using source meta information, to module 1040 with uploading resource to destination using destination meta information, and to module 1042 with returning uploaded meta information to the user machine. On validating the resources size against the drop section, the meta information of the resources along with the source and destination application will be shared to the resource sharing server, which in turn will download the resources from the source application and upload the same to the destination application and the meta information of the uploaded resources will be returned to the user's machine. The received uploaded meta information will be sent to the destination application's inline frame by triggering a custom ‘drop’ event, using which the destination application's inline frame will construct the resources in the drop section UI as shown in FIG. 6. The flowchart 1000 ends at module 1044 with refreshing view to show uploaded resource.

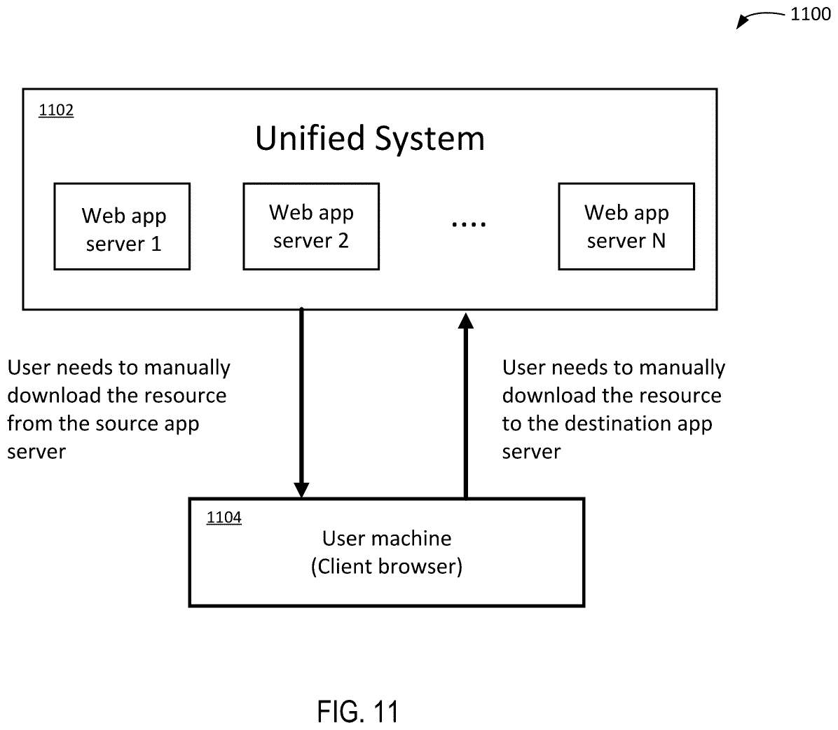

The architecture of a resource sharing system without the resource sharing server is illustrated in FIG. 11, which is a diagram 1100 of a unified system of a software suite 1102 and a user machine 1104. In the diagram 1100, the unified system of the software suite 1102 includes one or more web application servers and the user machine 1104 is connected to the unified system. Any download or upload operation happens between the user machine and the unified system directly.

In existing methods, when there is a need to share resources among applications in a software suite, the user must download the resource from a source application. The resource shared can be an attachment in an email, a file saved in a folder, a file shared in a messaging application, a file shared in an internal forum, or the like. Other resources may include events in a workflow, calendar, or tasks. The downloaded resource is thus saved on the user machine 1104. The user must upload the resource to the destination application again manually. This manual uploading and downloading process utilizes network resources. Also, a copy of the downloaded resource exists in the user machine until the user deletes it manually.

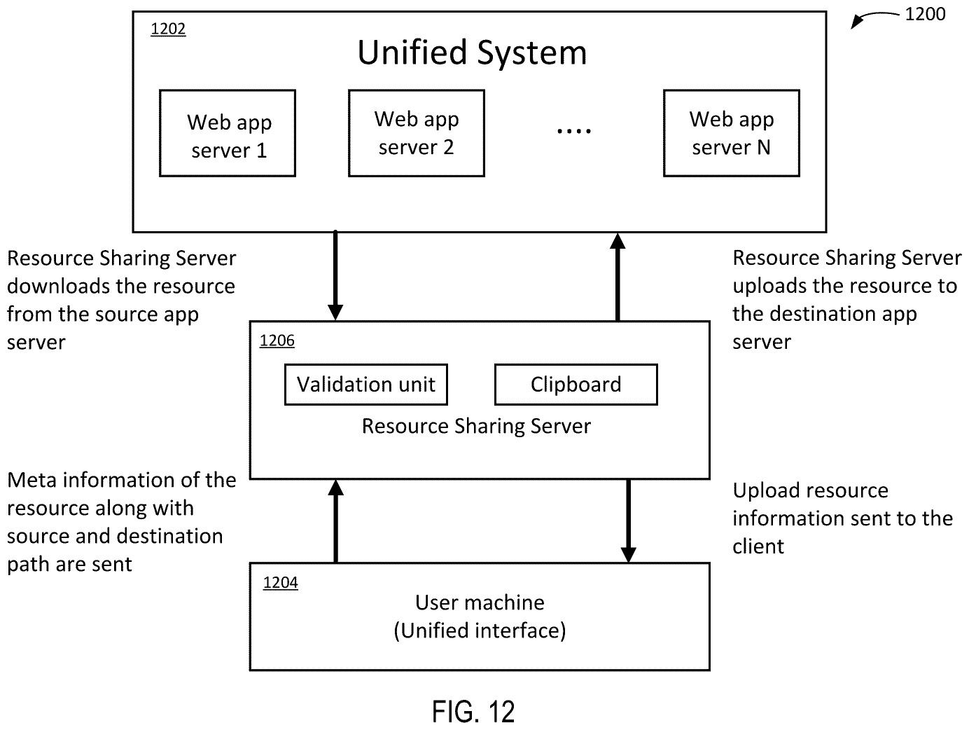

To overcome the above problems, resource sharing takes place with the help of a resource sharing server. FIG. 12 is a diagram 1200 of resource sharing from a unified software suite system 1202 from a user machine 1204 using a resource sharing server 1206 intermediary. Resource sharing in the workplace as shown in FIG. 12, happens between two applications in a seamless way by sharing meta information. In an example of operation, when a user copy and pastes, at the user machine 1204, a resource from one application to another, the resource sharing server 1206 downloads the resource from the application servers 1202, specifically a source application server, and uploads the same to a destination application server of the unified software suite system 1202.

The application servers 202 (FIG. 2) described previously are compatible with the unified software suite system 1202. Moreover, when using a unified software suite system, the application servers 202 can be implemented as part of the unified software suite system.

The resource sharing server 1206 includes validation unit and clipboard. The validation unit validates the download payload and upload payload information before initiating download and upload operations from and to the web applications. In a specific implementation, payload includes unique identification of a file along with file name, file size, file type, and source/destination directory/path from where the file has to be downloaded/uploaded. The validation unit checks for allowable file size of the resource to be shared. The validation unit also checks whether the resource shared is a proprietary file. The proprietary file is particular to an organization. The clipboard in the server is used to store the meta information of the resource when a ‘Copy and Paste’ event is initiated amongst web applications.

The user machine 1204 sends the meta information such as file name, file type and file size to the resource sharing server 1206 along with the source and destination information. Because the user machine sends only the meta information of the resource to the resource sharing server, not much of the user's network data is being utilized. The resource sharing server uses the meta information to transfer resources from the source to the destination. The resource sharing server acts as an intermediate server and holds the meta information of the resource. Once the resource is shared to the destination, the resource sharing server will send the uploaded meta information to the user machine. In a specific implementation, validation unit can also be in client machine to reduce the number of requests to the server and for data integrity to ensure the accuracy and consistency of the resource.

In a specific implementation, a unified interface is rendered on the user machine, through which one or more web applications can be selected as possible source and destination applications by the user. A user indication is received to copy a resource termed as ‘WARS’ (Web Applications Resource Sharing) from the selected source application. The user indication may be keyboard shortcuts, context menu or ‘Copy’‘Paste’ icons, wherein context menu includes options like ‘Copy’, ‘Paste’, etc. The context menu is displayed by the application's inline frames. An application's (parent window) inline frame is used to load another application inside it (child window). Examples of keyboard shortcuts are CTRL+C (for copy) and CTRL+V (for paste) in WINDOWS OS; COMMAND+C (for copy) and COMMAND +V (for paste) in MAC OS, etc.

The unified system of software suite (example ZOHO Workplace application suite) consists of a collection of web application servers, for example, ZOHO Workdrive server, ZOHO Cliq server, ZOHO Connect server, ZOHO mail server, etc.

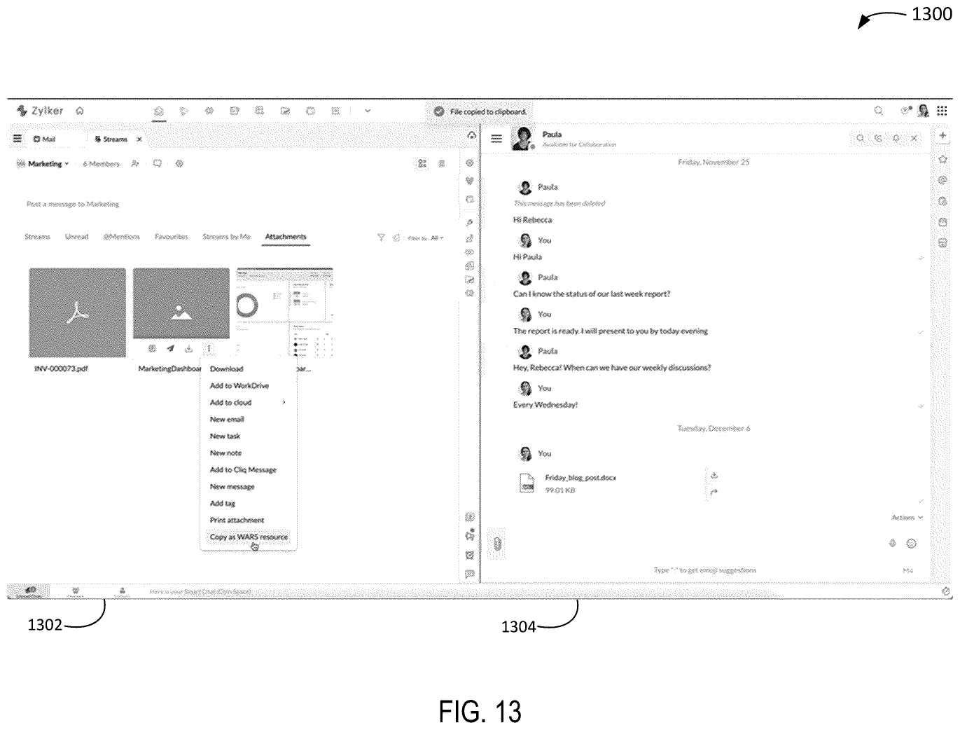

FIG. 13 is a diagram 1300 of a sample screen shot of split screen option for resource sharing, including a first screen 1302 and a second screen 1304. The split screen option makes resource sharing convenient for the user without having to move back and forth between application tabs. The left side of the split screen shows the source application included in the suite, from where the resource is being copied, for example, ZOHO Streams. The right side of the split screen indicates the destination application included in the suite, where the resource needs to be pasted, for example ZOHO Cliq. Upon selecting the ‘Copy’ option the resource's meta information is copied to the clipboard.

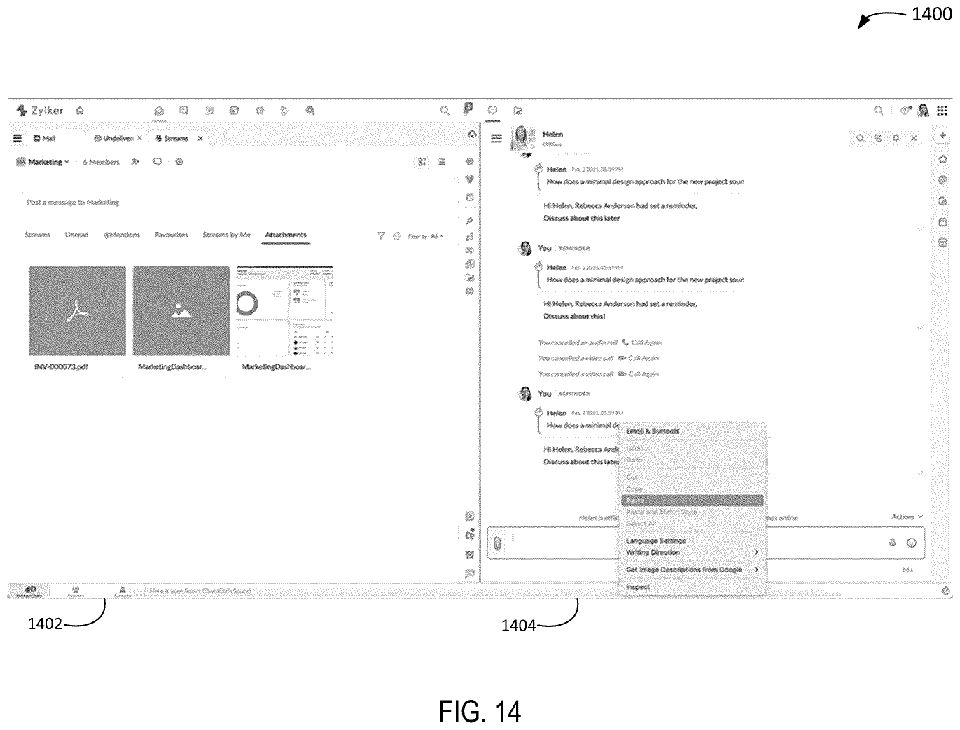

FIG. 14 is a diagram 1400 illustrative of a selection of ‘Paste’ option through context menu in the required drop region of destination application, for example, ZOHO Cliq, in a split screen including a first screen 1402 and a second screen 1404. The drop region of the selected destination is identified and validated.

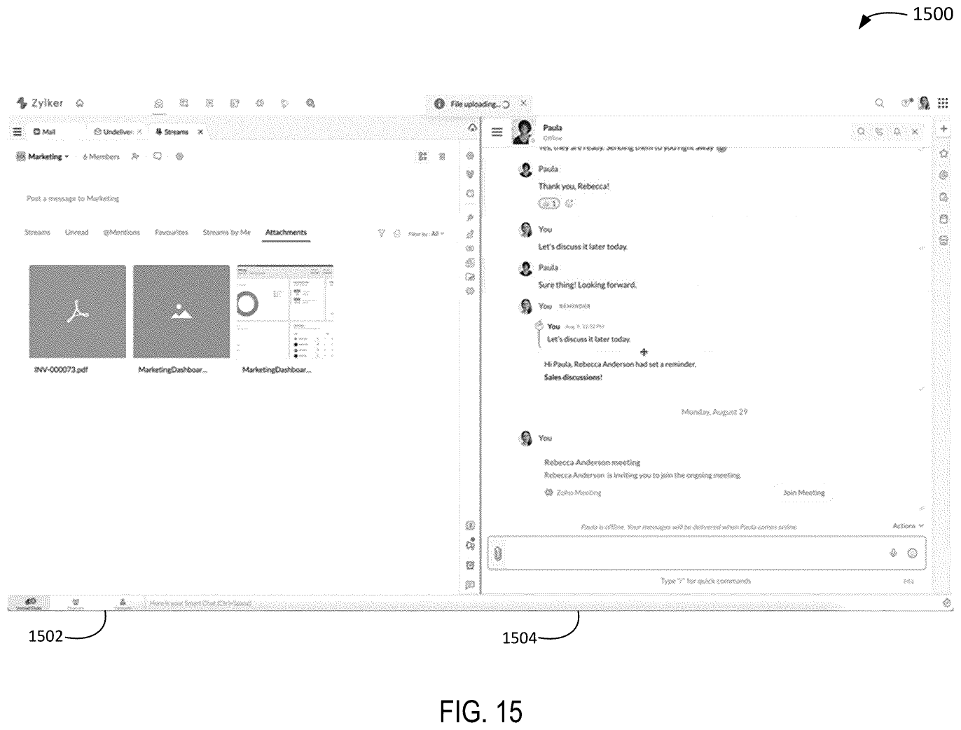

FIG. 15 is diagram 1500 of a screen shot of resource sharing in progress, in a split screen including a first screen 1502 and a second screen 1504. After validation, the resource sharing server uses the meta information in the clipboard to download the resource from the source application for example, ZOHO Streams and upload the same to the destination application for example, ZOHO Cliq. The screen shot depicts a file uploading notification in user's unified interface.

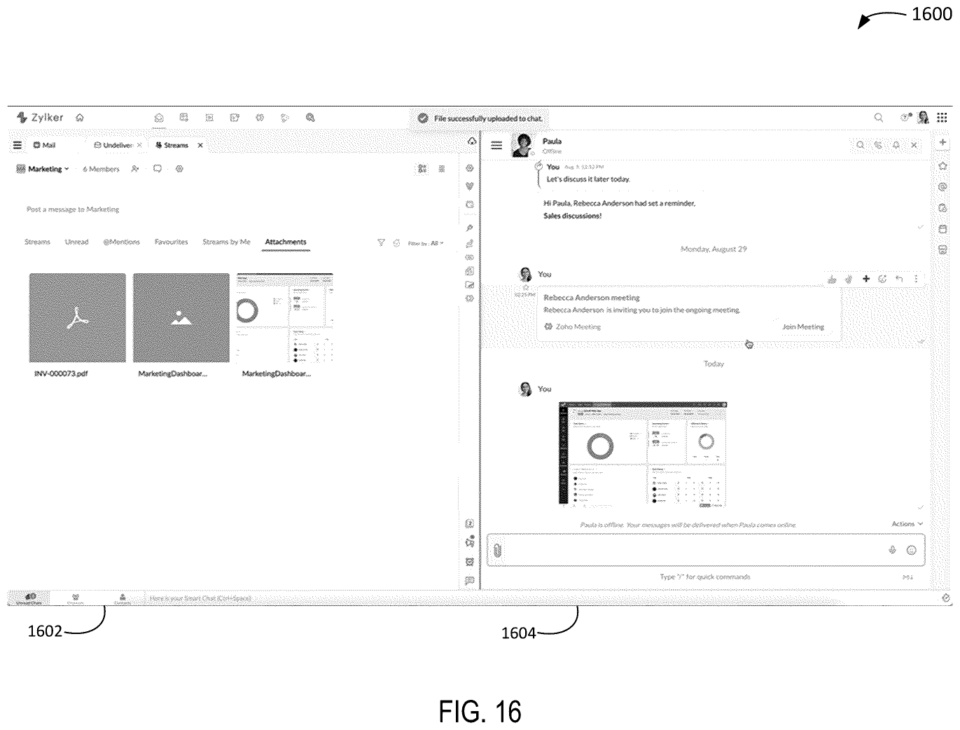

FIG. 16 is a diagram 1600 of a screen shot of resource shared to destination, in a split screen including a first screen 1602 and a second screen 1604. The screen shot depicts a resource from the source application for example, ZOHO Streams is being successfully uploaded at the destination application for example, ZOHO Cliq from the clipboard.

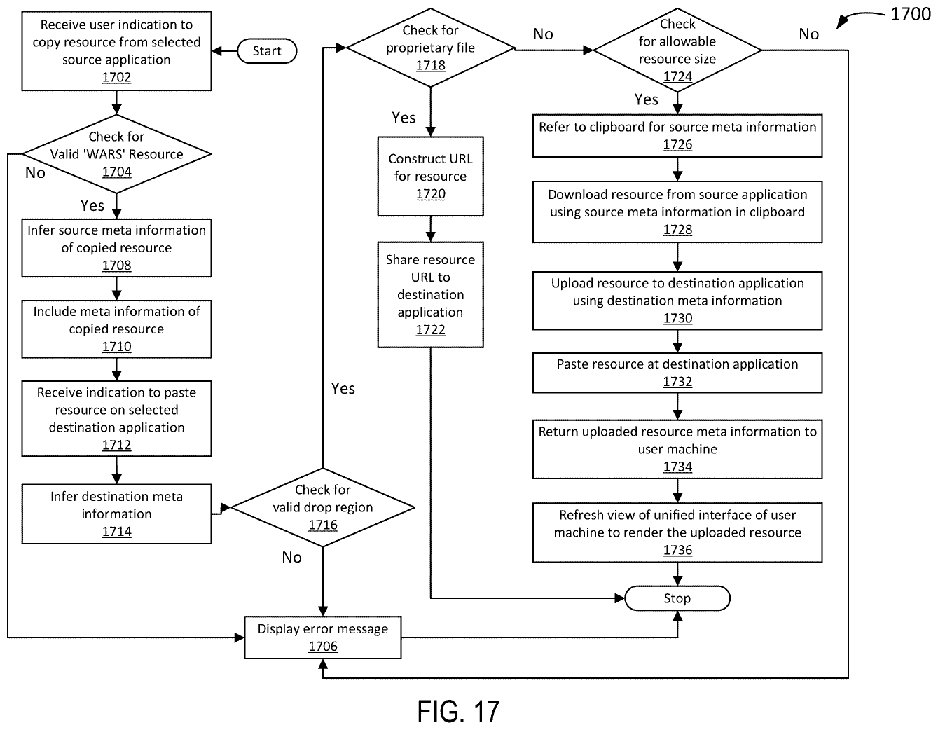

FIG. 17 is a flowchart 1700 of a method for implementing resource sharing using a resource sharing server clipboard. The flowchart 1700 starts at module 1702 with receiving an indication to copy a resource from a selected source application. For example, when a user provides an indication for copying the resource from the selected source application, source meta information along with the source application details of the resource are sent to the resource sharing server. The flowchart 1700 continues to decision point 1704 where it is determined whether the resource is a valid ‘WARS’ resource. If not (1704-No), the flowchart 1700 ends at module 1706 where an error message is displayed. Valid ‘WARS’ resource includes the resources available in web applications in a unified software suite system.

Otherwise (1704-Yes), the flowchart 1700 continues to module 1708 where source meta information of the copied resource is inferred. In a specific implementation, if the resource is a valid ‘WARS’ resource, then the source meta information of the resource is included in the clipboard in a unique format to differentiate from other copied data.

The flowchart 1700 continues to module 1710 with including the meta information in the clipboard. In a specific implementation, each time a user indication is received to copy a resource, the source meta information of the resource is included in the clipboard after validation.

The flowchart 1700 continues to module 1712 with receiving an indication to paste resource on selected destination application. A user indication can be received to copy a single resource from a single source application. A user indication can be received to copy multiple resources from a single source application. A user indication can be received to copy multiple resources from multiple source applications.

The flowchart 1700 continues to module 1714 with inferring destination meta information and to decision point 1716 where it is determined whether a valid drop region is available. If validation fails (1716-No), then the flowchart 1700 ends at module 1706 as described previously. In a specific implementation, the server publishes the stored contents in the clipboard to the client. When an indication is received to paste the resource, the drop region on the selected destination application is identified and validated. The drop region can be any content editable region such as input, text box elements etc. as shown by way of example in FIG. 14. The application's inline frames will send the destination meta information to the parent window along with the ‘Paste’ event. After successful validation, the ‘Paste’ event is initiated. If validation fails, the application will ignore the ‘Paste’ event along with message to notify the user.

Otherwise (1716-Yes), the flowchart 1700 continues to decision point 1718 where it is determined whether the resource is a proprietary file. If so (1718-Yes), the flowchart 1700 continues to module 1720 where a URL is constructed for the resource and ends at module 1722 with sharing the resource URL to the destination application. In a specific implementation, when a ‘Paste’ event is initiated, the resource is checked for proprietary file format. If the resource is identified to be of specific proprietary file format, then an URL for the resource is constructed and shared to the destination along with the required access permission, for example Read access, Comment access, etc. For a proprietary file, there is no restriction on the size of the resource shared.

If it is determined the resource is not a proprietary file (1718-No), then the flowchart 1700 continues to decision point 1724 where it is determined whether the resource is of an allowable size. If not (1724-No), the flowchart 1700 ends at module 1706 as described previously. To validate and restrict or allow the resource to be shared to the destination application, application's inline frames will be sending the allowed size, so that the size of the resource copied will be validated against the same. For destination applications/regions supporting multiple resources to an entity such as composing an email, writing a new forum post, writing a new streams message etc., a method will be invoked so that the application's inline frames will validate the remaining size allowed in that entity with the copied resource's size. If the resource is within the allowable size, then the resource can be pasted. If the size of the resource goes beyond the allowable size, then an error message is displayed on the user machine.

If it is determined the resource is of an allowable size (1724-Yes), the flowchart 1700 continues to module 1726 with referring to the clipboard for source meta information, to module 1728 with downloading the resource from source application using source meta information in the clipboard, and to module 1730 with uploading the resource to the destination application using destination meta information. In a specific implementation, based on validation results, the resource(s) is downloaded from the source application and uploaded to the destination application. As an acknowledgement of ‘Paste’ event, the meta information of the uploaded resources will be sent to the user machine. The meta information is retained in the clipboard until ‘Paste’ event is initiated. The resource sharing server is responsible for downloading the resource from the source application and uploading it to the destination application. By using the resource sharing server, a copy of the resource does not exist in the user machine. Manual downloading of the resource to the user machine is prevented thereby avoiding litigation on security grounds. The received meta information will be sent to the destination application's inline frame by triggering a custom ‘Paste’ event, using which the destination application's inline frame will construct the resources in the destination's paste region.

The flowchart 1700 continues to module 1732 with pasting the resource at a destination application. A user indication can be received to paste a single resource to a single destination application. A user indication can be received to paste multiple resources to a single destination application. A user indication can be received to paste single resource to multiple destination applications. A user indication can be received to paste multiple resources to multiple destination applications.

The flowchart 1700 continues to module 1734 with returning uploaded resource meta information to the user machine. In a specific implementation, the server publishes the meta information of all the copied resources to the client's clipboard. During the ‘Paste’ event the user is given the choice to select one or more of the resource(s) for pasting from the clipboard. Storing meta information in the server-side clipboard will help the user to share the required resource across multiple web applications, different sessions and different devices. The flowchart 1700 ends at module 1736 with refreshing the view of the unified interface of the user machine to render the uploaded resource.

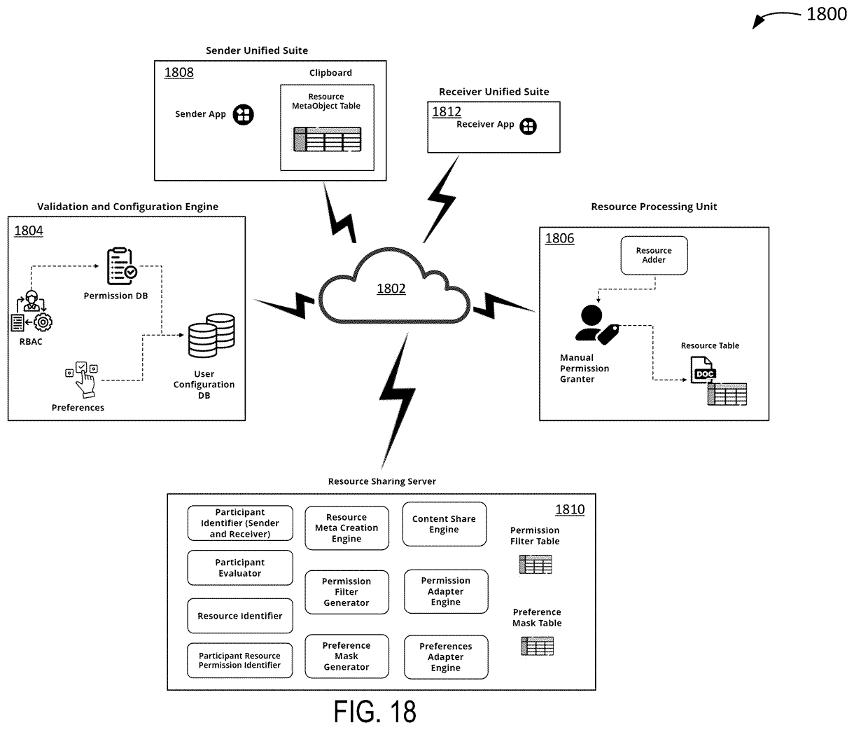

FIG. 18 is a diagram 1800 of an example of an architecture that incorporates seamless resource sharing using Drag & Drop or Copy-Paste with a resource sharing server intermediary. The diagram 1800 includes a CRM 1802, a validation and configuration engine 1804, a resource processing engine 1806, a sender unified suite engine 1808, a resource sharing server 1810, and a receiver unified suite engine 1812. In a specific implementation, the CRM 1802 is a network, as described previously.

The validation and configuration engine 1804 is responsible for validating the access levels of users and also configures their levels of permissions and preferences individually based on a set of predefine rules in the organization. A Role Based Access Control (RBAC) engine assigns permissions to users in the organization. These permissions reflect access controls allowed for the users in the organizational hierarchy. A permission datastore stores the list of permissions that can override the RBAC, for example, a user can explicitly share a folder and its content with user in lower levels in the organizational hierarchy. The permissions assigned to users at this level may be coarse-grained. In a specific implementation, apart from the permissions, users have preferences such as, reading the document in a preferred language, preferring specific choice of colors in the document in case of a user with color blindness, etc. These permissions and preferences are stored in a user configuration datastore by the validation and configuration engine.

The resource processing engine 1806 is responsible for the collecting resources generated in the organization and adding them to a resource pool using a resource adder engine. Information such as Resource IDentifier (RID), permissions set by a resource creator to the resource, and the like, are added to a resource table.

The sender unified suite engine 1808 includes multiple apps running in a unified software suite on sender's machine. A resource (R) from one of these apps (say App1) on which a Sender(S) operates can be shared with one other ReCeiver (RC) operating on any other app (say App2, not necessarily App1). This application facilitates the sharing of the resource by both Drag & Drop and Copy-Paste. If Copy-Paste is used, a resource metaObject (including, in a specific implementation, RID, Permissions assigned to the Resource by the Resource generator, Permissions of the sending Sender(S) on the resource, and the Timestamp of the share) is stored in a resource metaObject table.

The resource sharing server 1810 manages resources that are being shared across different users across different apps within a unified software suite. Components in the resource sharing server include the following: Participant Identifier, Participant Evaluator, Resource Identifier, Participant Resource Permission Identifier, Resource Meta Creation Engine, Preference Adapter Engine, Permission Filter Generator, Preference Mask Generator, Permission Filter Table, Preference Mask Table, and Content Share Engine.

Participant Identifier: On initiating a resource sharing operation by the Sender(S) in the sender app, the resource sharing server listens to the mouse movement and tracts the user who is initiating the resource sharing and the Receiver (RC) to whom the resource is being shared. The location where the Drag or Copy action is initiated is captured as the Sender(S) and the one where the Drop or the Paste is done is captured as the Receiver (RC) and their Identities are fetched by the Participant Identifier to facilitate further resource sharing process.

Participant Evaluator: Once the Participants' Identities are known, the Participant Evaluator verifies if the Sender(S) and Receiver (RC) are authorized to take part in this resource sharing process.

Resource Identifier: The Resource Identifier fetches the identity of the resource being shared using the Resource Identity Table in the Resource Processing Unit. The permissions assigned to these resources by the resource generator are also accessed from this table.

Participant Resource Permission Identifier: This engine is responsible for assessing the permissions the sending and receiving users have on the resource being shared. It takes into account the hierarchy of the users in the organization, the special permissions given for a user to share or access the resource, etc.

Resource Meta Creation Engine: During the resource sharing operation, the MetaObject of the resource being shared is generated by this engine. This Resource MetaObject (RMO) is a set of information about the resource and the Sender(S) who initiates the resource sharing process. It comprises the Resource ID (RID), the permissions given to this resource by the resource creator, the Sender(S) and the timestamp at which this action is initiated.

Permission Filter Generator: The Sender(S) who initiates the resource sharing has permissions associated with this resource based on the hierarchy of the Sender(S) in the organization. This hierarchical permission and other permissions defined by the organization have a direct implication on the resource R being shared. Based on these permissions, a subset of the resource (Rsub) is the one that is permitted to be shared with the Receiver (RC).

Permission Filter Table: This table stores the permission filters generated for a Sender (S) on the resource R. These permission filters are used by the RSS to generate the subset of the shared resource based on the allowed permissions.

Permission Adapter Engine: This engine is responsible for applying the permissions on the original resource to get the allowed subset of the resource Rsub that could be shared with the Receiver (RC). This subset may even be the whole set if Sender(S) and Receiver (RC) have the maximum permission on the resource R.

Preference Mask Generator: The Receiver (RC) can register his/her preferences with the User Configuration datastore in the Validation and Configuration Engine. These preferences can either transform/modify the resource based on the choice of the receiver such as translating the language of the resource into a preferred language, render the resource in specific colors to facilitate easy reading for users with color blindness, augment the resource by highlighting captions, etc. The Preference Mask Generator generates the necessary mask for the Receiver (RC) to be supplied to the Preference Adapter Engine to modify and/or augment the shared resource.

Preference Mask Table: The set of all preference masks for all the participants who have registered with the Preference Adapter Engine is made available in this table to avoid regenerating the same mask. This table acts as a repository that can be updated and used as long as the Receiver (RC) prefers this.

Preference Adapter Engine: The Preference Adapter Engine applies the Preference Mask on the resource input given to and it transforms and/or augments the resource to get the final format of the resource Rfinal that is preferred by the Receiver (RC).

Content Share Engine: The Content Share Engine is responsible for downloading the resource R from the source location, which is then subjected to the permission filter and preference mask in the RSS. The Content Share Engine is also responsible for uploading the final resource Rfinal to the receiving user Ub in the destination app.

The receiver unified suite engine 1812 includes a receiver app that runs in the receiver unified suite. The Receiver (RC) operating this receiver app registers its preferences if any with the RSS. The Receiver (RC) receives the final resource Rfinal which is a processed output of the original resource R getting filtered by the Permission Filter and masked using the Preference Mask. Dynamic Preference Adapter in the Receiver Unified Suite gets information about the preferences of the receiver from the User Configuration Datastore of the Validation and Configuration Engine. This caters to the needs of the preferences at the receiver by applying the necessary modification/changes required to the shared resource and makes it accessible for to the receiver.

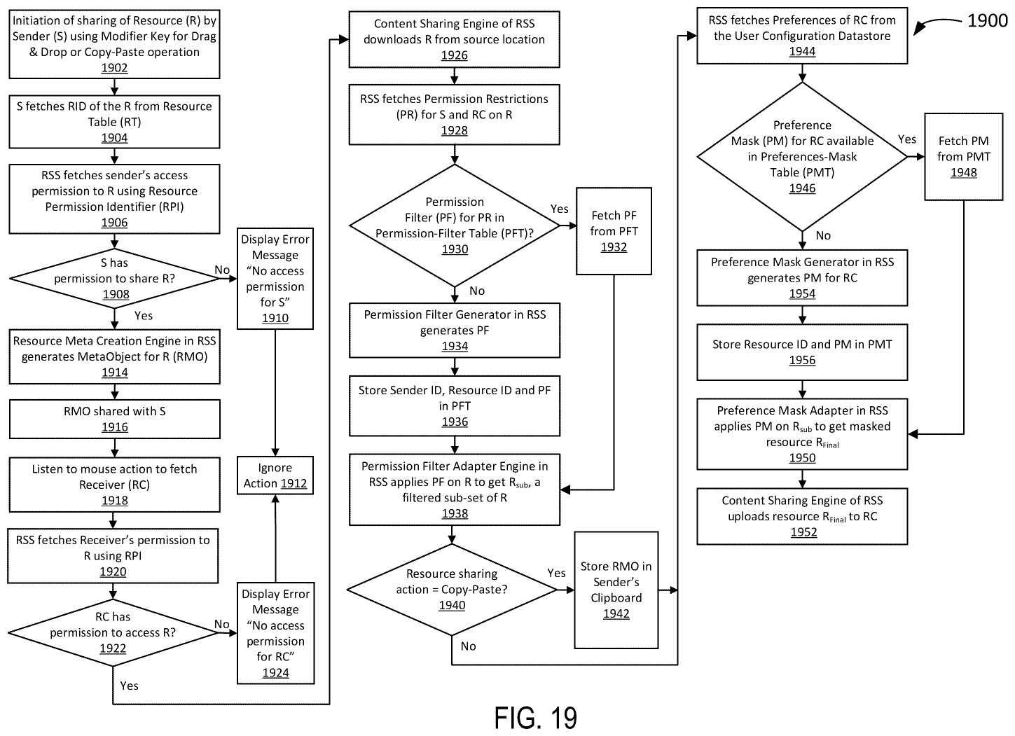

FIG. 19 is a flowchart 1900 of a method for resource sharing using Drag & Drop or Copy-Paste operation with a Modifier Key. The flowchart 1900 starts at module 1902 with initiating sharing of Resource (R) by Sender(S) using a Modifier Key for Drag & Drop or Copy-Paste operation. The flowchart 1900 continues to module 1904 with S fetching resource ID (RID) of R from a Resource Table (RT) and to module 1906 with Resource Sharing Server (RSS) fetching sender's access permission to R using a Resource Permission Identifier (RPI). In a specific implementation, the RSS fetches the sender's access permission to R from a User Configuration Datastore using the RPI. Depending upon implementation-and configuration-specific factors, R can be considered a bundle of resources (“subresources”), some of which may have different permissions than others; the system will allow appropriate subresources to be accessed in the manner described hereafter while restricting access to other subresources, or otherwise treating subresources differently in the manner described hereafter.

The flowchart 1900 continues to decision point 1908 where it is determined whether S has permission to share R. If it is determined S does not have permission to share R (1908-No), the flowchart 1900 continues to module 1910 with displaying an error message “No access permission for Sender” and ends at module 1912 with ignoring the action. If, on the other hand, it is determined S has permission to share R (1908-Yes), the flowchart 1900 continues to module 1914 where a resource metaobject creation engine in the RSS generates a Resource MetaObject (RMO) for R. In a specific implementation, the RMO comprises of Resource Identifier, Permissions assigned to the Resource by the Resource generator, Permissions of the Sender S on the resource, and the Timestamp of the share.

The flowchart 1900 continues to module 1916 where RMO is shared with S, to module 1918 where mouse action to fetch receiver (RC) is listened for, and to module 1920 where RSS fetches receiver's permission to R using RPI. The Drop or Paste action is tracked and the RC in the destination is fetched by the RSS.

The flowchart 1900 continues to decision point 1922 where it is determined whether RC has permission to access R. If it is determined RC does not have permission to access R (1922-No), the flowchart continues to module 1924 with displaying an error message “No access permission for receiver” and ends at module 1912 as described previously. If, on the other hand, it is determined RC has permission to access R (1922-Yes), the flowchart 1900 continues to module 1926 where a content sharing engine of the RSS downloads R from a source location and to module 1928 where the RSS fetches permission restrictions (PR) for S and RC on R. In a specific implementation, the access permission for RC is also retrieved from a User Configuration datastore and, if permitted, the Content Share Engine downloads the resource (R) from the source location.

The Participant Resource Permission Identifier in the RSS fetches Permission Restrictions (PR) for Sender(S) and Receiver (RC) on the Resource (R) from the User Configuration datastore.

The flowchart 1900 continues to decision point 1930 where it is determined whether a Permission Filter (PF) for PR is in a Permission-Filter Table (PFT). The RSS checks for the corresponding Permission Filter (PF) in the Permission-Filter Table (PFT) and, if available, the available filter is used and, if not available, the Permission Filter Generator in the RSS generates

Permission Filter (PF) for this resource for the respective Sender and Receiver. Accordingly, if it is determined a PF for PR is in the PFT (1930-Yes), the flowchart continues to module 1932 where the PF is fetched from the PFT. The flowchart 1900 then continues to module 1938, which will be described momentarily.

If, on the other hand, it is determined a PF for PR is not in the PFT (1930-No), the flowchart 1900 continues to module 1934 where a permission filter generator in the RSS generates a PF and to module 1936 where sender ID, resource ID, and PF are stored in the PFT.

The flowchart 1900 continues to module 1938 where a permission filter adapter engine in the RSS applies PF on R to get R_{sub}, a filtered subset of R. In a specific implementation, if the participants in the resource sharing have the no restrictions in the Permissions, this subset will be the whole set of the Resource (R) in which case R_{sub}=R.

The flowchart 1900 continues to decision point 1940 where it is determined whether the resource sharing action is Copy-Paste. If it is determined the resource sharing action is Copy-Paste (1940-Yes), the flowchart 1900 continues to module 1942 wherein RMO is stored in sender's clipboard. In a specific implementation, if the operation is Copy Paste, then the RMO is stored in the Clipboard of the Sender Software Suite to be used for future use as long as the Clipboard is active. Then the flowchart 1900 continues to module 1944. If it is determined the resource sharing action is not Copy-Paste (1940-No), the flowchart 1900 continues to module 1944, skipping module 1942. At module 1944, the RSS fetches preferences of RC from the user configuration datastore.

The flowchart 1900 continues to decision point 1946 where it is determined whether a

Preference Mask (PM) for RC is available in a Preferences Mask Table (PMT). In a specific implementation, the RSS checks if the Preference Mask (PM) for the Receiver (RC) is available in the PMT; if available the same mask is used and if not, the Preference Mask Generator in RSS generates Preference Mask (PM) for Receiver (RC). Accordingly, if it is determined PM for RC is available in the PMT (1946-Yes), the flowchart 1900 continues to module 1948 where the PM is fetched from the PMT. Then the flowchart continues to module 1950 where a preference mask adapter in the RSS applies PM on R _{sub}to get masked resource R _{sub} and ends at module 1952 where content sharing engine of the RSS uploads resource R _{final} to RC. If, on the other hand, it is determined the PM for RC is not available in the PMT (1946-No), the flowchart 1900 continues to module 1954 where a preference mask generator in the RSS generates a PM for RC, to module 1956 where Resource ID and PM are stored in the PMT, and to module 1950, which was described previously.

What is claimed is:

1. A method comprising:
sharing meta information of a resource comprising one or more files with a resource sharing server as part of a resource sharing operation;
applying a permissions filter and a preference mask to the resource;
validating the one or more files using access permissions of participants of the resource sharing operation;
generating a sharable subset of the resource;
wherein resource sharing events occur across users, across applications by way of the resource sharing server.

2. The method of claim 1 comprising:
using the preference mask to transform the sharable subset of the resource.

3. The method of claim 1 comprising:
using the preference mask to augment the sharable subset of the resource.

4. The method of claim 1 wherein:
a sender initiates the resource sharing operation from a user machine;
the resource is not downloaded to the user machine.

5. The method of claim 1 comprising:
using the permissions filter to generate the sharable subset of resources based on the allowed permissions.

6. The method of claim 1 comprising:
providing split screen functionality within a browser window on a user machine to a sender that initiates the resource sharing operation from the user machine.

7. The method of claim 1 wherein:
the resource sharing operation includes a Drag & Drop event on a split screen.

8. The method of claim 1 wherein the resource sharing operation includes a Copy-Paste event, comprising storing a Resource MetaObject (RMO) in a clipboard.

9. The method of claim 1 comprising:
initiating the resource sharing operation using a modifier key in association with a Drag & Drop or Copy-Paste operation.

10. The method of claim 1 comprising:
generating a Resource MetaObject (RMO) for the resource that is shared with a sender of the resource.

11. The method of claim 1, wherein a content sharing engine of a resource sharing server downloads the resource form a source location, comprising fetching permission restrictions for a sender and a receiver of the resource.

12. The method of claim 1, wherein a permission filter generator of a resource sharing engine generates a permission filter, comprising applying the permission filter to the resource to obtain a filtered subset of the resource.

13. The method of claim 1, wherein a preference mask generator engine of a resource sharing server generates a preference mask for a receiver, comprising applying the preference mask to the resource to obtain a filtered subset of the resource.

14. The method of claim 1 comprising:
applying a permission filter to the resource to obtain a filtered subset of the resource;
applying a preference mask to the resource to obtain a final subset of the resource.

15. The method of claim 1 comprising:
constructing a uniform resource locator (URL) for the resource;
sharing the URL with to a destination application.

16. The method of claim 1, wherein the resource sharing operation includes a Drag & Drop operation, comprising creating a ghost image in association with the Drag & Drop operation.

17. A system comprising:
a sender application for sharing meta information of a resource comprising one or more files with a resource sharing server as part of a resource sharing operation;
a validation and configuration unit for validating the one or more files using access permissions of participants in the resource sharing operation;
a resource sharing server including a permission filter generator and a preference mask generator, wherein:
the permission filter generator generates a permissions filter using a user configuration DB;
the preference mask generator generates a preference mask using the user configuration DB;
the resource sharing server includes a permission adapter engine for applying the permissions filter on the shareable resource and generating a shareable subset of the resource;
the resource sharing server includes a preference adapter engine for applying the preference mask on the generated shareable subset of the resource;
resource sharing events occur across users, across applications by way of the resource sharing server.

18. The system of claim 17, wherein a permission filter table in the resource sharing server stores the permission filters generated by the permission adapter engine for each sender application.

19. The system of claim 17, wherein a preference mask table in the resource sharing server stores the preference mask generated by the preference adapter engine for each receiver application.

20. The system of claim 17, wherein a content share engine in the resource sharing server downloads the resource and uploads the modified resource to a receiver application.
